(19) United States
(12) Patent Application Publication
(10) Pub. No.: US 2025/0209479 A1
(43) Pub. Date: Jun. 26, 2025

(54) TASK AVAILABILITY PREDICTION IN AN ONLINE CONCIERGE SYSTEM

(71) Applicant: Maplebear Inc., San Francisco, CA (US)

(72) Inventors: Sai Kannan Sampath, Berkeley, CA (US); Radhika Anand, Redwood City, CA (US); Marina Tanasyuk, San Francisco, CA (US); Youdan Xu, Burlingame, CA (US); Matthew Donghyun Kim, Seattle, WA (US); Michael Chen, San Francisco, CA (US)

(21) Appl. No.: 18/395,474

(22) Filed: Dec. 22, 2023

(51) Int. Cl. G06Q 30/0202; G06Q 30/0204

(52) U.S. Cl. CPC G06Q 30/0202; G06Q 30/0205

(57) ABSTRACT

An online concierge system predicts how available tasks will be for a particular assistant in the assistant's current context. Task availability is computed differently in different embodiments. In a first embodiment, the task availability assessment functionality predicts an expected gap between demand for task performance and supply of assistants to perform those tasks. This expected gap is compared to historical gap values in a market segment (e.g., a particular geographical region during a particular span of time) to make a rough assessment of task availability relative to the average of that market segment. In a second embodiment, a set of features relevant to nearby retailer locations, the current geographic location, and/or the particular assistant is input to a deep learning model, which accordingly predicts a specific amount of time until the assistant receives a first task assignment.

### BACKGROUND

Concierge systems, which enable assistants to provide assistance to a customer with the customer's errands or other personal business, are of value to both the assistants and the customers, providing the customers with the ability to accomplish tasks for which they lack the time or ability, and the assistants with flexible employment opportunities.

A well-designed concierge system should take into account the needs of both the customers who wish to complete tasks, and the assistants who carry out those tasks on behalf of the customers. In particular, it can be frustrating for assistants when they wait without success to have tasks assigned to them by the concierge system, particularly when non-trivial preparation for work (such as preparing to drive or otherwise prepare to await tasks) is involved. This can result in significant loss of morale on the assistant side of the concierge ecosystem.

### SUMMARY

In accordance with one or more aspects of the disclosure, an online concierge system has task availability assessment functionality that predicts how available tasks will be for a particular assistant in the assistant's current context (e.g., a current location and time of the assistant). The assistant can accordingly decide, based on the prediction, whether he or she wishes to prepare to receive tasks, or whether it would be better to wait until a later time.

Task availability is computed differently in different embodiments. In a first embodiment, the task availability assessment functionality predicts an expected gap between demand for task performance and supply of assistants to perform those tasks. This expected gap is compared to historical gap values in a market segment (e.g., a particular geographical region during a particular span of time) to make a rough assessment of task availability relative to the average of that market segment. In a second embodiment, a set of features relevant to nearby retailer locations, the current geographic location, and/or the particular assistant is input to a deep learning model, which accordingly predicts a specific amount of time until the assistant receives a first task assignment.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 illustrates components of the task availability assessment module of FIG. 2, according to some embodiments.

FIGS. 4A-4C illustrate example user interfaces for providing the user with a task availability prediction, according to some embodiments.

FIG. 5 is a flowchart of steps for providing a user with a prediction of task availability, according to some embodiments.

### DETAILED DESCRIPTION

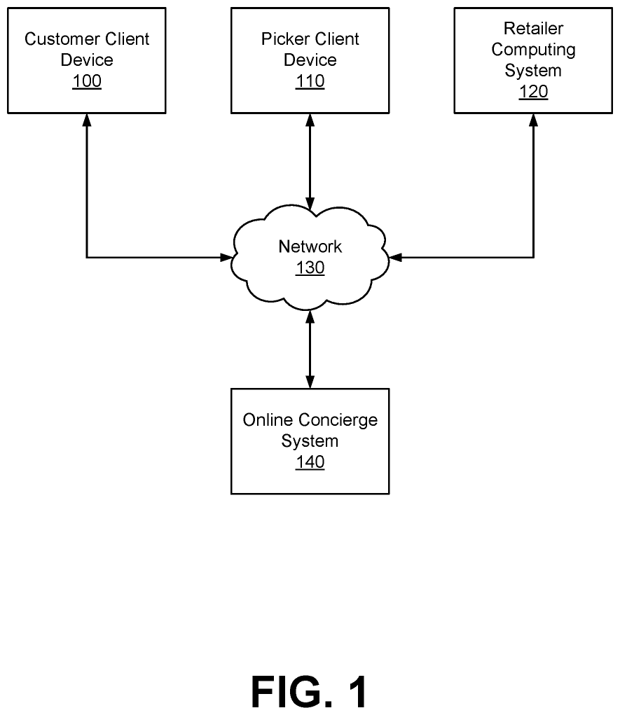

FIG. 1 illustrates an example system environment for an online concierge system 140 in which assistants (known as “pickers”) obtain items from retailers on behalf of customers, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item”, as used herein, means a good or product that can be provided to the customer through the online concierge system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item at the retailer, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. When a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer, so that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi-or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 provides item data indicating which items are available at a particular retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer.

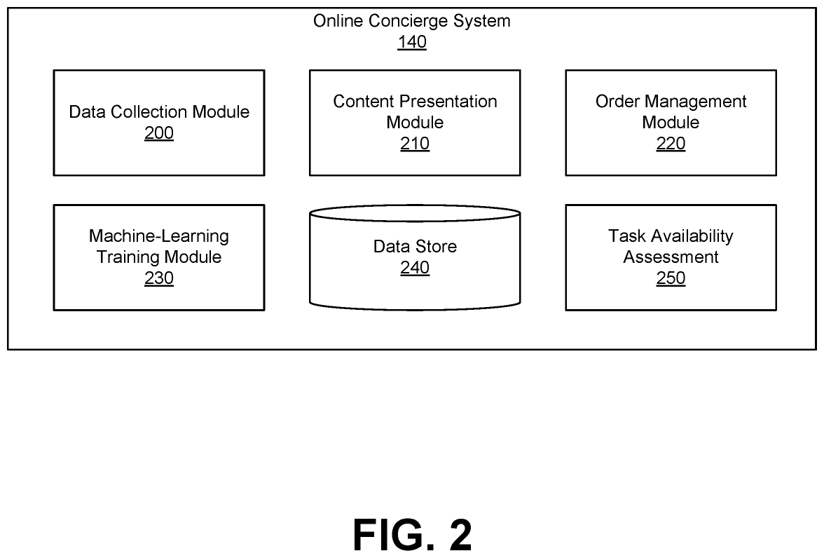

As an example, the online concierge system 140 may allow a customer to order groceries from a grocery store retailer. The customer's order may specify which groceries they want delivered from the grocery store and the quantities of each of the groceries. The customer's client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In some embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits an ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine-learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine-learning models and may be stored in the data store 240.

In some embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and assigns the orders to pickers for service based on picker data. For example, the order management module 220 assigns an order to a picker based on the picker's location and the location of the retailer from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

In some embodiments, the order management module 220 determines when to assign an order to a picker based on a delivery timeframe requested by the customer with the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the requested timeframe. Thus, when the order management module 220 receives an order, the order management module 220 may delay in assigning the order to a picker if the requested timeframe is far enough in the future (i.e., the picker may be assigned at a later time and is still predicted to meet the requested timeframe).

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit, to the picker client device 110, instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of the order. In some embodiments, the order management module 220 computes an estimated time of arrival of the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine-learning training module 230 trains machine-learning models used by the online concierge system 140. The online concierge system 140 may use machine-learning models to perform functionalities described herein. Example machine-learning models include regression models, support vector machines, naïve bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, or transformers. A machine-learning model may include components relating to these different general categories of model, which may be sequenced, layered, or otherwise combined in various configurations.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include customer data, picker data, item data, or order data. In some cases, the training examples also include a label which represents an expected output of the machine-learning model. In these cases, the machine-learning model is trained by comparing its output from input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The online concierge system 140 additionally includes a task availability assessment module 250 that analyzes the present context for a picker to assess the prospects for the picker to be assigned a task. This enables the picker to determine whether it is currently appropriate for the picker to wait to be assigned a task, or whether (in the case of current lack of customer demand) it would be better to look for a task at a later time.

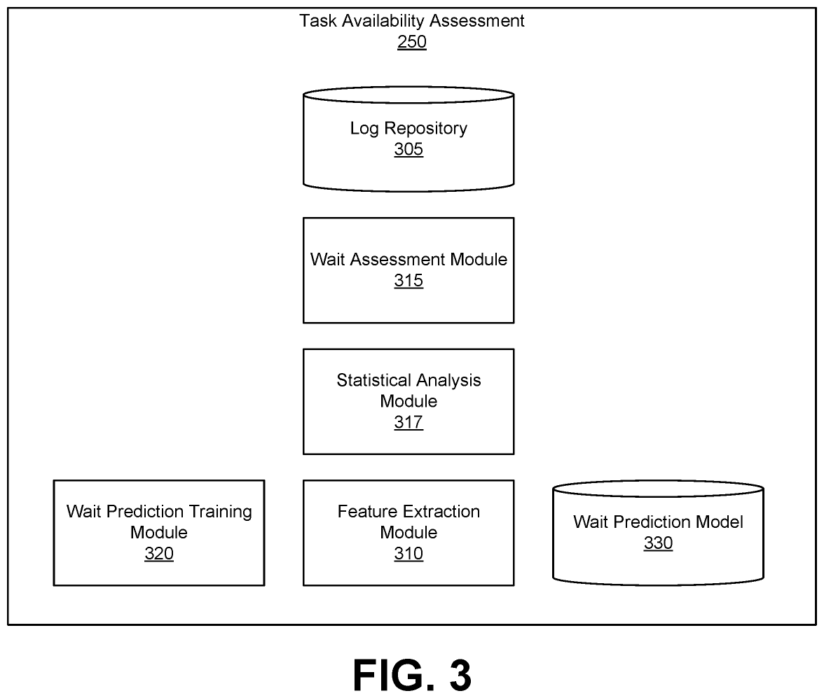

FIG. 3 illustrates components of the task availability assessment module 250 of FIG. 2, according to some embodiments. Two primary embodiments are described below, representing two different approaches to the problem of assessing demand: a first embodiment quantifying supply-demand gaps within particular geographic zones to predict a general level of demand in those zones at particular times, and a second embodiment using a deep learning model to directly predict a certain amount of time before a particular picker receives his or her first task. (The first embodiment is hereafter referred to as the “gap prediction embodiment,” and the second embodiment as the “deep learning embodiment.”)

The task availability assessment module 250 has a log repository 305 that is used (directly or indirectly) by a wait assessment module 315 to assess a likely level of demand of customers for tasks to be carried out by pickers (and, correspondingly, a degree of delay until the picker receives a task). In embodiments using deep learning to generate specific wait time predictions, the task availability assessment module 250 additionally includes a feature extraction module 310 and a wait prediction model 330, and may optionally also include a wait prediction training module 320 that generates the wait prediction module based on the log repository 305. These components are now described in more detail.

The log repository 305 includes information obtained from the client devices 100, 110 of the various customers and pickers of the online concierge system 140. For example, in some embodiments, the information includes times that pickers set their status to be available (or unavailable) for receiving tasks via the online concierge system 140, times that the pickers were assigned tasks, times that customers submitted a task for completion by the online concierge system, retailer locations at which tasks were to be performed (e.g., items were to be obtained as part of an order), and the like.

The wait assessment module 315 predicts a measure of task availability. The pickers can use the predicted measure to decide whether it is worthwhile to begin a work session-that is, to indicate that they are ready to begin accepting customer tasks (as well as to perform any preparation needed to be ready to begin accepting tasks). The exact type and computation of the prediction differs in different embodiments.

In the gap prediction embodiment, the wait assessment module 315 relies upon data generated by a statistical analysis module 317 that inspects the log data to assess the typical distribution of the “supply-demand gap” for different segments of the market. Knowing the typical distributions of different market segments allows comparison of given gaps to the baselines for those segments and thereby giving pickers a sense of how a predicted gap compares to what is customary for that segment. (The “supply-demand gap”—or simply “gap”, for brevity—is the difference between the demand of consumers for performance of tasks, and the supply of pickers who wish to be assigned to perform those asks, evaluated at a particular moment in time.)

More specifically, the statistical analysis module 317 first reads the data collected in the log repository 305. In the gap prediction embodiment, the log repository 305 stores <location, time, aggregate gap>tuples derived for the various pickers. In some embodiments, the location and time are the location and time of the picker at the time that she ended her work session, and the aggregate gap is evaluated based on all the retail locations within some region around the picker (e.g., the region within an N mile radius, such as N =5) at the end of the work session. (The aggregate gap for a set of retail locations is the sum of the supply-demand gaps at the various retailer locations.)

The statistical analysis module 317 groups the tuples into market segments, such as by grouping based on time and location values of the tuples. In some embodiments, for example, the time is bucketed by a time unit such as month, and the location is bucketed according to predetermined geographical zones. Thus, for example, there might be a segment defined for the <month=10, zone=17>pair, another segment for the <month=10, zone=18>pair, and the like.

Within a segment, the statistical analysis module 317 performs percentile analysis for the aggregate gap values of the segment's tuples. For example, in some embodiments the aggregate gap values are grouped into four quartiles, and the values defining their boundaries identified. In other embodiments, the P10, P25, and P75 values are identified. The boundary values then define a sequence of ranges for the aggregate gaps, so that any given aggregate gap can be unambiguously binned into exactly one of the ranges. Being able to assign a range number to any given aggregate gap is a form of normalization, characterizing a given aggregate gap against customary aggregate gaps for that market segment. (For example, light-demand/long-wait times for being assigned a task might be typical for a sparsely-populated rural area, but atypical for a heavily-populated urban area. Thus, such mapping of an aggregate gap to a range specific to a market segment allows describing demand in terms of typical expectations for that segment.)

In the gap prediction embodiment, the wait assessment module 315 uses the percentile analysis data previously computed by the statistical analysis module 317 when predicting task availability for a picker at runtime. The wait assessment module 315 first uses a previously-trained gap prediction model to predict an aggregate gap for the picker at some future time that is a predetermined amount of time from the current time. For example, in some embodiments the gap prediction model predicts what the aggregate gap will be an hour in the future. In some embodiments, the features input by the gap prediction model include a location (e.g., the current geographic location of the user) and a time (e.g., the current time). (In some embodiments the gap prediction model is trained by using the input features, and the previously observed gap values measured at the predetermined distance of time (e.g., an hour in the future) from the times corresponding to the input features, as ground truth for training.)

In the deep learning embodiment, the wait assessment module 315 uses a wait prediction model 330 to predict a specific amount of time that a given picker will likely wait before being assigned his first task, and a feature extraction module 310 to identify the features that serve as input values for the wait prediction model 330. In some embodiments, the task availability assessment module 250 itself trains the wait prediction model 330.

The feature extraction module 310 determines the values of the features that are used for the input to (and training of) the wait prediction model 330. In various embodiments, the features include some or all of the following:

Retailer location/location/zone features: Features associated with the stores, warehouses, or other locations within the geographical region in which the pickers might carry out tasks, including:
The predicted gap value between supply and demand of retailer locations that are in the M-mile radius around picker's current location.
The predicted aggregate gap value between supply and demand of the retailer locations in the picker's geographic zone.
Average task volume for retailer locations that are in the M-mile radius around picker's current location.
Average TTA (time to acceptance: the time when a task is accepted after its performance was requested by the customer) of retailer locations that are in the M-mile radius around the picker's current location.
Average TTA of the geographic zone of the picker.
Number of tasks in the past N (e.g., 2) hours for retailer locations that are in the M-mile radius around the picker's current location.
Numbers of tasks in the past N (e.g., 2) hours for the picker's geographic zone.
Number of tasks at the same time for the last time unit (e.g., a week) for stores that are in the M-mile radius around the picker's current location.
Number of tasks at the same time for the last time unit (e.g., a week) for the picker's geographic zone.
Number of online pickers that are in the M-mile radius around the picker's current location.
Number of retailer locations that are in the M-mile radius around the picker's current location.
Number of online shoppers in the picker's geographic zone.
Historical average waiting times for pickers to be assigned a task in the picker's geographic zone.

Geographical region features: Characteristics of a zone or other geographical region, unrelated to retailer locations, including:
Weather events (e.g., storm) taking place in the picker's geographic zone.
Any other disruptive events occurring in the picker's geographic zone (e.g., traffic, concerts, holidays, parades, etc.).

Picker features: Features describing the picker handling the task, such as the picker's

rating from customers, tier, or time spent handling tasks as part of the online concierge system 140.

The wait prediction model 330 is a model trained through deep learning (e.g., a transformer or other neural network). It takes as input the features determined by the feature extraction module 310 and outputs a predicted amount of time until the picker is assigned the first task of his work session (assuming that the work session begins at that moment).

In some embodiments, a wait prediction training module 320 trains the wait prediction model 330. In these embodiments, the wait prediction training module 320 uses the feature extraction module 310 to extract, from the log repository 305, the same features that are input to the wait prediction model 330. Additionally, the wait prediction training module 320 analyzes the log repository 305 to determine, for each set of work session feature values, the actual wait times until the first task of the work session was assigned to the picker; these actual wait times serve as ground truth labels for training. The extracted features and corresponding actual wait times are the training set upon which the wait prediction model 330 is trained.

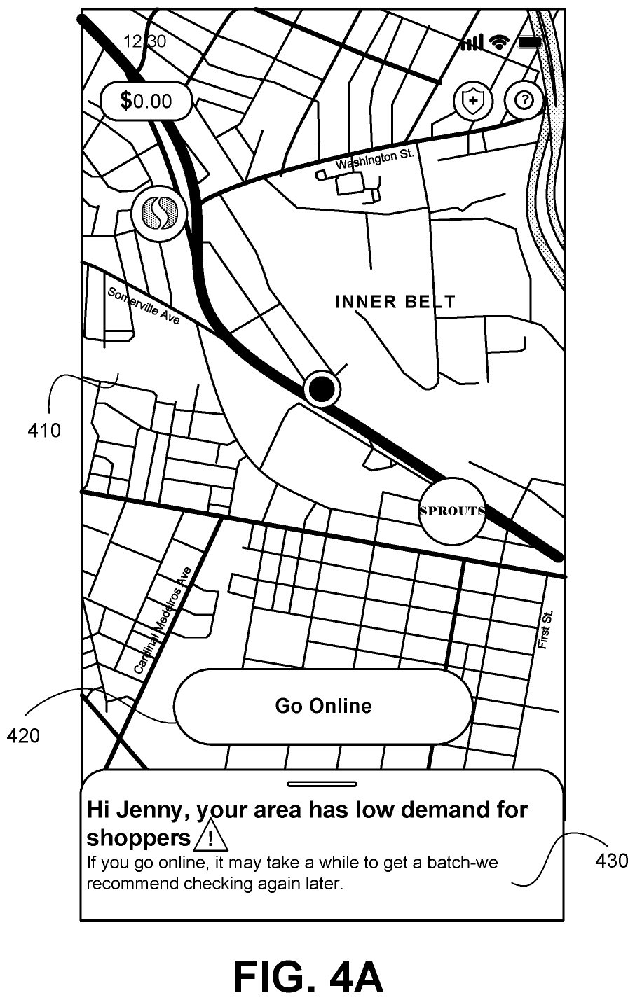

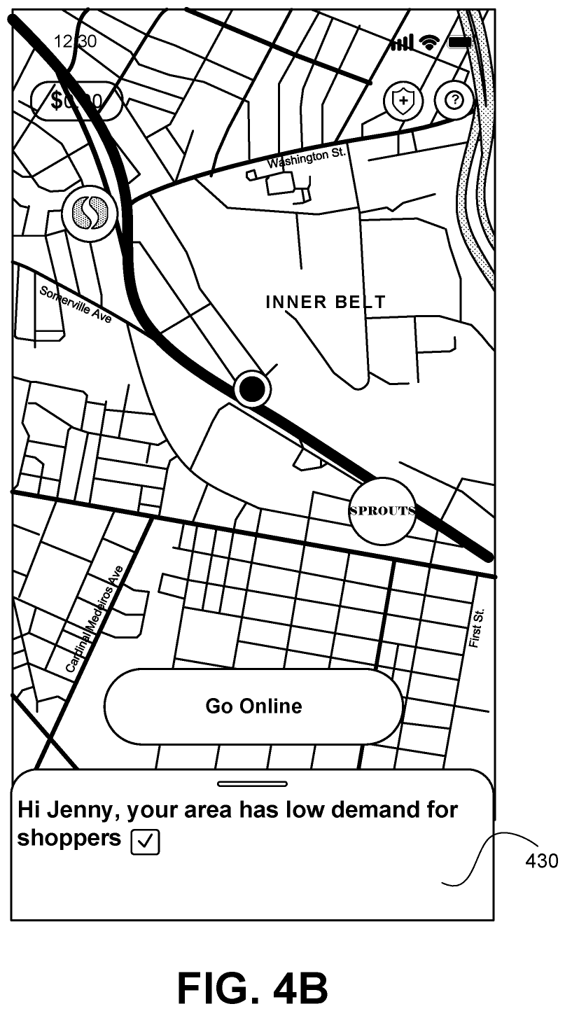

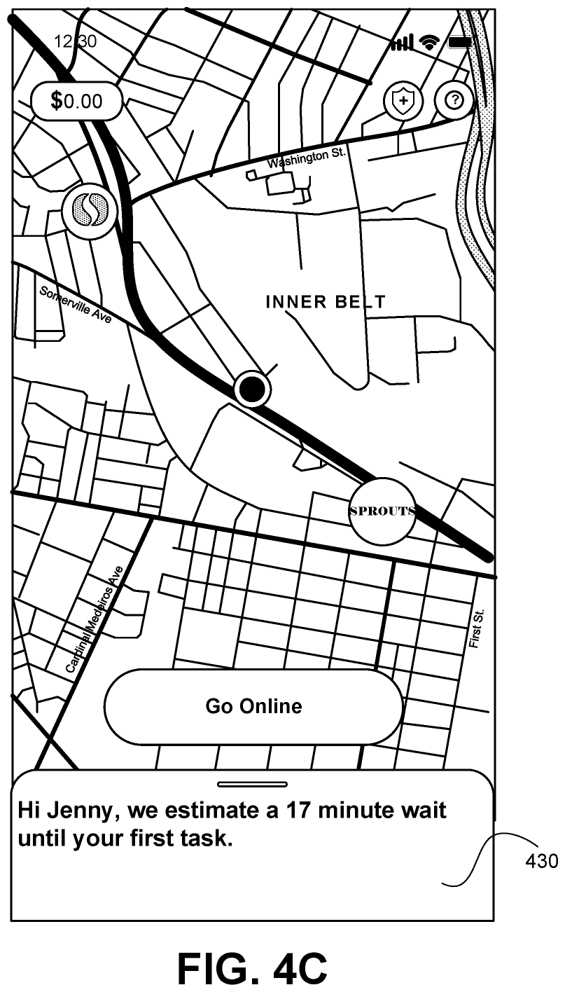

The task availability assessment module 250 module uses the prediction from the wait assessment module 315 to inform the picker. Based on the prediction, the picker can decide whether she wishes to solicit new tasks at the present time. In some embodiments, the prediction can be displayed within a graphical user interface of the picker client device 110. For example, FIG. 4A displays an example smartphone graphical user interface including a map area 410 displaying an electronic map of the area around the picker's current location, a user interface element 420 permitting the picker to go online and begin a work session (signaling that she is available to be assigned tasks), and a summary 430 based on the prediction made by the wait assessment module 315. In the example of FIG. 4A, the summary 430 notes that there is low customer demand for task performance in the picker's current geographic area (in view of the number of pickers already wishing to be assigned tasks), relative to the usual task availability in that area. (This presents the approach of the gap prediction embodiment, since it presents its assessment of task availability in terms of expected ranges, e.g., “low demand.”) Similarly, FIG. 4B presents the sample example user interface, but one in which the summary 430 is that there is currently a high customer demand for task performance. A picker upon seeing the summary 430 of FIG. 4B would likely feel encouraged to begin a work session, whereas the summary of 430 would likely lead him to conclude that it is not an auspicious time to look for tasks, and that it would be better to try again later. FIG. 4C, in contrast, presents a summary 430 that provides a specific estimate of time until the picker is assigned a first task, as in the deep learning embodiment.

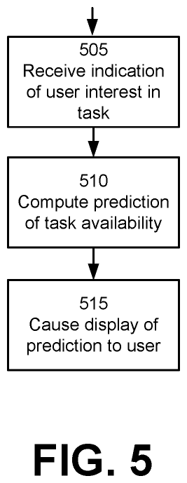

FIG. 5 is a flowchart of steps for providing a picker or other user with a prediction of task availability, according to some embodiments. In step 505, the task availability assessment module 250 receives, from the user, an indication of the user's interest in being assigned a task. For example, the indication of the user's interest could be sent automatically by the client device of the user when the user executes an application for interacting with the online concierge system 140, which implicitly signals interest in receiving a task. Alternatively, the user could explicitly signal interest, such as by selecting a “Check task availability” user interface element in a user interface of the application.

Accordingly, the wait assessment module 315 computes a prediction of task availability, such as a general level of supply-demand gap relative to the usual gap in the area, or a specific estimate of time until receipt of a first task.

With the task availability predicted, the task availability assessment module 250 causes the prediction to be displayed in a user interface of the user (e.g., as in FIGS. 4A-4C), or otherwise uses the prediction on behalf of the user.

Alternative embodiments may include more, fewer, or different steps from those illustrated in FIG. 5, and the steps may be performed in a different order from that illustrated in FIG. 5. These steps may be performed by an online concierge system (e.g., online concierge system 140). Additionally, each of these steps may be performed automatically by the online concierge system without human intervention.

Although the foregoing has described task wait assessment within the context of a picker shopping at a retailer for items of a customer order, the principles disclosed herein can be more generally applied within the context of a task assignment system in which some set of users wishes to be assigned tasks to perform on behalf of other users.

### ADDITIONAL CONSIDERATIONS

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated for the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method for estimating task availability, performed at a computer system comprising a processor and a computer-readable medium, the method comprising:
receiving, from a client device of a user, an indication of user interest in being assigned a task, and a current location of the user;
generating, based at least in part on the current location of the user, a prediction of task availability; and
causing the client device of the user to display, in a user interface thereof, a representation of the prediction of task availability;
wherein the prediction of task availability comprises:
a level of task availability relative to historical levels in a geographic region encompassing the current location of the user, the level of task availability generated by:
accessing logged data comprising geographic location, time, and aggregate gap measures computed from work sessions of users, the aggregate gap measures representing an aggregate difference between numbers of customer requests for performance of a task and numbers of users requesting to be assigned a task to perform;
grouping the aggregate gap measures according to geographic location;
for each of the groups, performing percentile analysis of the aggregate gap measures to identify boundary values defining a set of ranges;
identifying the geographic region encompassing the current location of the user;
predicting a gap for the geographic region at a predetermined future time; and
identifying one of the set of ranges corresponding to the predicted gap; or
an estimate of time until availability of a first task to the user from a retailer location within a given radius of the current location of the user.

2. The method of claim 1, wherein the prediction of task availability comprises an estimate of time until availability of a first task to the user from a retailer location within a given radius of the current location of the user.

3. The method of claim 2, further comprising:
accessing, for each of a plurality of prior work sessions of one of a plurality of users, logged values for a plurality of features associated with the prior work session;
accessing, for each of the work sessions, a wait time of the user corresponding to the work session to be assigned a first task in that work session;
training a wait time prediction model based on the wait times and on the plurality of features for the plurality of users, wherein the wait time prediction model inputs values for the plurality of features and outputs a predicted wait time until assignment of a task.

4. The method of claim 3, wherein generating the prediction comprises:
identifying values for the plurality of features for a current work session of the user;
providing the identified values as input to the trained wait prediction model; and
obtaining a predicted wait time until assignment of a task to the user.

5. The method of claim 3, wherein accessing the logged values for the plurality of features comprises accessing logged values for features associated with a geographic zone in which the user is currently located.

6. The method of claim 3, wherein accessing the logged values for the plurality of features comprises accessing logged values for features associated with a retail location within a predetermined distance of the user.

7. The method of claim 3, wherein accessing the logged values for the plurality of features comprises accessing logged values for features associated with the user.

8. A computer system comprising:
a computer processor; and
a computer-readable medium storing instructions that when executed by the computer processor perform actions comprising:
receiving, from a client device of a user, an indication of user interest in being assigned a task, and a current location of the user;
generating, based at least in part on the current location of the user, a prediction of task availability; and
causing the client device of the user to display, in a user interface thereof, a representation of the prediction of task availability;
wherein the prediction of task availability comprises:
a level of task availability relative to historical levels in a geographic region encompassing the current location of the user, the level of task availability generated by:
accessing logged data comprising geographic location, time, and aggregate gap measures computed from work sessions of users, the aggregate gap measures representing an aggregate difference between numbers of customer requests for performance of a task and numbers of users requesting to be assigned a task to perform;
grouping the aggregate gap measures according to geographic location;
for each of the groups, performing percentile analysis of the aggregate gap measures to identify boundary values defining a set of ranges;
identifying the geographic region encompassing the current location of the user;
predicting a gap for the geographic region at a predetermined future time; and
identifying one of the set of ranges corresponding to the predicted gap; or
an estimate of time until availability of a first task to the user from a retailer location within a given radius of the current location of the user.

9. The computer system of claim 8, wherein the prediction of task availability comprises an estimate of time until availability of a first task to the user from a retailer location within a given radius of the current location of the user.

10. The computer system of claim 9, the actions further comprising:
accessing, for each of a plurality of prior work sessions of one of a plurality of users, logged values for a plurality of features associated with the prior work session;
accessing, for each of the work sessions, a wait time of the user corresponding to the work session to be assigned a first task in that work session;
training a wait time prediction model based on the wait times and on the plurality of features for the plurality of users, wherein the wait time prediction model inputs values for the plurality of features and outputs a predicted wait time until assignment of a task.

11. The computer system of claim 10, wherein generating the prediction comprises:
identifying values for the plurality of features for a current work session of the user;
providing the identified values as input to the trained wait prediction model; and
obtaining a predicted wait time until assignment of a task to the user.

12. The computer system of claim 10, wherein accessing the logged values for the plurality of features comprises accessing logged values for features associated with a geographic zone in which the user is currently located.

13. The computer system of claim 10, wherein accessing the logged values for the plurality of features comprises accessing logged values for features associated with a retail location within a predetermined distance of the user.

14. The computer system of claim 10, wherein accessing the logged values for the plurality of features comprises accessing logged values for features associated with the user.

15. A non-transitory computer-readable storage medium storing instructions that when executed by a computer processor perform actions comprising:
receiving, from a client device of a user, an indication of user interest in being assigned a task, and a current location of the user;
generating, based at least in part on the current location of the user, a prediction of task availability; and
causing the client device of the user to display, in a user interface thereof, a representation of the prediction of task availability;
wherein the prediction of task availability comprises:
a level of task availability relative to historical levels in a geographic region encompassing the current location of the user, the level of task availability generated by:
accessing logged data comprising geographic location, time, and aggregate gap measures computed from work sessions of users, the aggregate gap measures representing an aggregate difference between numbers of customer requests for performance of a task and numbers of users requesting to be assigned a task to perform;
grouping the aggregate gap measures according to geographic location;
for each of the groups, performing percentile analysis of the aggregate gap measures to identify boundary values defining a set of ranges;
identifying the geographic region encompassing the current location of the user;
predicting a gap for the geographic region at a predetermined future time; and
identifying one of the set of ranges corresponding to the predicted gap; or
an estimate of time until availability of a first task to the user from a retailer location within a given radius of the current location of the user.

16. The non-transitory computer-readable storage medium of claim 15, wherein the prediction of task availability comprises an estimate of time until availability of a first task to the user from a retailer location within a given radius of the current location of the user.

17. The non-transitory computer-readable storage medium of claim 16, the actions further comprising:
accessing, for each of a plurality of prior work sessions of one of a plurality of users, logged values for a plurality of features associated with the prior work session;
accessing, for each of the work sessions, a wait time of the user corresponding to the work session to be assigned a first task in that work session;
training a wait time prediction model based on the wait times and on the plurality of features for the plurality of users, wherein the wait time prediction model inputs values for the plurality of features and outputs a predicted wait time until assignment of a task.

18. The non-transitory computer-readable storage medium of claim 17, wherein generating the prediction comprises:
identifying values for the plurality of features for a current work session of the user;
providing the identified values as input to the trained wait prediction model; and
obtaining a predicted wait time until assignment of a task to the user.

19. The non-transitory computer-readable storage medium of claim 17, wherein accessing the logged values for the plurality of features comprises accessing logged values for features associated with a geographic zone in which the user is currently located.

20. The non-transitory computer-readable storage medium of claim 17, wherein accessing the logged values for the plurality of features comprises accessing logged values for features associated with a retail location within a predetermined distance of the user.
